(19) United States
(12) Patent Application Publication
(10) Pub. No.: US 2017/0336983 A1
(43) Pub. Date: Nov. 23, 2017

(54) SERVER DEVICE INCLUDING CACHE MEMORY AND METHOD OF OPERATING THE SAME

(71) Applicants: SEUNG JUN ROH, BUCHEON-SI (KR); DONGHUN LEE, DAEGU (KR)

(72) Inventors: SEUNG JUN ROH, BUCHEON-SI (KR); DONGHUN LEE, DAEGU (KR)

(21) Appl. No.: 15/443,097

(22) Filed: Feb. 27, 2017

(30) Foreign Application Priority Data
May 17, 2016 (KR) 10-2016-0060336

(51) Int. Cl. G06F 3/06; G06F 12/128; G06F 12/0875; G06F 12/0811

(52) U.S. Cl. CPC G06F 3/0607; G06F 12/0811; G06F 12/128; G06F 12/0875; G06F 3/0619; G06F 3/0685; G06F 3/0679; G06F 3/065; G06F 2212/452

(57) ABSTRACT

A server device stores cache data in a cache memory and stores a first list associated with first cache data having a first characteristic among the cache data and a second list associated with second cache data having a second characteristic among the cache data in an operating memory. In a case where at least one of the first and second lists is updated, the server device transmits update information to the cache memory.

### CROSS-REFERENCE TO RELATED APPLICATIONS

This U.S. non-provisional patent application claims priority under 35 U.S.C. §119 of Korean Patent Application No. 10-2016-0060336, filed on May 17, 2016, the entire contents of which are hereby incorporated by reference.

### BACKGROUND

The disclosure relates to server devices, and more particularly, to a server device including a cache memory and a method of operating the same.

A semiconductor memory device is embodied using a semiconductor such as silicon Si, germanium Ge, gallium arsenide GaAs, indium phosphide InP, etc. A semiconductor memory device is classified as a volatile memory device or a nonvolatile memory device.

Because of the advantages of high capacity, low noise, low power, etc., a flash memory, which is a type of a nonvolatile memory device, is widely used as a storage device in various fields. A flash memory-based solid state drive (SSD) is used as large-capacity storage in a personal computer, a notebook, a work station, a server system, etc. The flash memory-based solid state drive (SSD) may also be used as various nonvolatile large-capacity storages which can be overwritten.

### SUMMARY

Example embodiments of the disclosure provide a method of operating a server device. The method may include storing, by a processor, cache data in a cache memory; storing, by the processor, a first list associated with first cache data having a first characteristic among the cache data and a second list associated with second cache data having a second characteristic among the cache data in an operating memory. In a case where at least one of the first and second lists is updated, the processor transmits update information to the cache memory,

Example embodiments of the disclosure provide a server device. The server device may include a cache memory storing cache data, an auxiliary memory device including a plurality of hard disk drives, and a processor storing a first list associated with first cache data having a first characteristic among the cache data and a second list associated with second cache data having a second characteristic among the cache data in an operating memory. In a case where at least one of the first list and the second list is updated, the processor transmits update information to the cache memory.

Example embodiments of the disclosure provide a server device. The server device may include a cache memory device having a nonvolatile memory and a cache memory manager. The cache memory manager receives a request for a page of data and determines a first affirmative outcome when the requested page is stored by the nonvolatile memory and has an address identified by either a first list or a second list stored by the cache memory manager; otherwise, the cache memory manager determines a negative outcome. All page addresses identified by the first list are mutually exclusive with all page addresses identified by the second list. The cache memory manager moves the address of the requested page to a position within the second list indicating the requested page is the most-recently requested page identified by the second list, in response to determining the first affirmative outcome.

### BRIEF DESCRIPTION OF THE FIGURES

Embodiments of the disclosure will be described below in more detail with reference to the accompanying drawings. The embodiments of the disclosure may, however, be embodied in different forms and should not be construed as limited to the embodiments set forth herein. Rather, these embodiments are provided so that this disclosure will be thorough and complete, and will fully convey the scope of the disclosure to those skilled in the art. Like numbers refer to like elements throughout.

FIG. 1 illustrates a block diagram of a server device according to an embodiment of the disclosure.

FIG. 2 is a block diagram illustrating a cache manager according to an embodiment of the disclosure.

FIG. 3 is a conceptual diagram of lists managed by a cache manager (CM) according to an embodiment of the disclosure.

FIG. 4 is a conceptual diagram for explaining a relation between lists managed by a cache manager and a cache memory according to an embodiment of the disclosure.

FIG. 5 is a flowchart illustrating an operation of a cache manager generating a list change signal according to an embodiment of the disclosure.

FIGS. 6 through 9 are conceptual diagrams of a process of generating a list change signal according to an embodiment of the disclosure.

FIGS. 10 through 13 are conceptual diagrams of a process of generating a list change signal according to another embodiment of the disclosure.

FIG. 14 is a drawing for explaining an operation of a cache manager in the case where a cache region includes a plurality of blocks according to an embodiment of the disclosure.

FIG. 15 is a drawing for explaining a process of assigning a weight value in units of blocks using a list change signal received according to an embodiment of the disclosure.

FIG. 16 is a drawing for explaining a process of performing garbage collection based on the weight value assigned according to an embodiment of the disclosure.

FIG. 17 is a block diagram illustrating a memory cell array according to another embodiment of the disclosure.

### DETAILED DESCRIPTION OF THE EMBODIMENTS

Embodiments of the disclosure will be described more fully hereinafter with reference to the accompanying drawings, in which embodiments of the disclosure are shown. This disclosure may, however, be embodied in many different forms and should not be construed as limited to the embodiments set forth herein. Rather, these embodiments are provided so that this disclosure will be thorough and complete, and will fully convey the scope of the disclosure to those skilled in the art. In the drawings, the size and relative sizes of layers and regions may be exaggerated for clarity. Like numbers refer to like elements throughout.

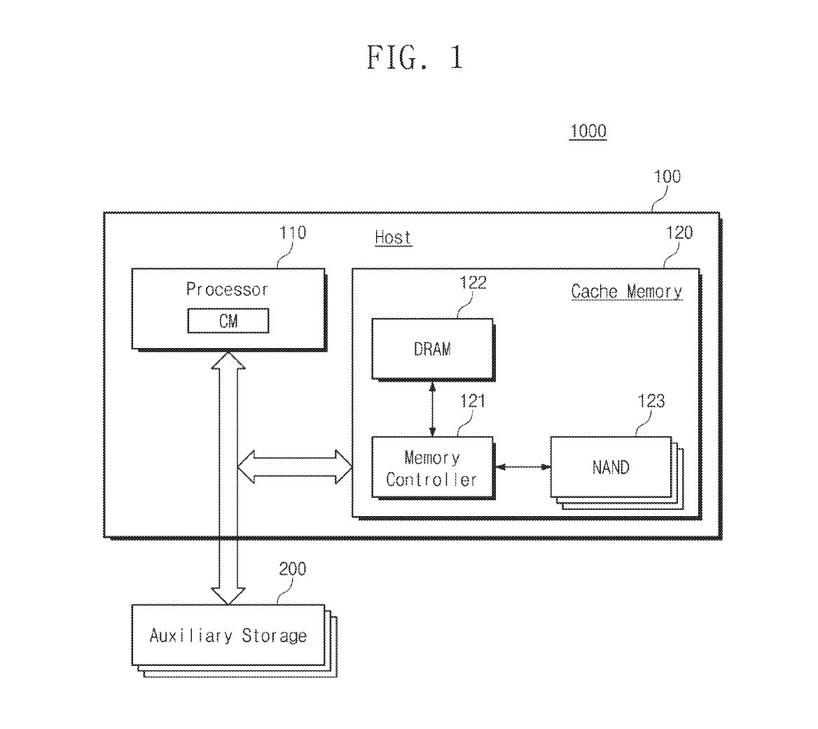

FIG. 1 illustrates a block diagram of a server device according to an embodiment of the disclosure. Referring to FIG. 1, a server device 1000 may include a host device 100 and an auxiliary storage device 200. The host device 100 may include a host processor 110 and a cache memory 120.

The host processor 110 can control an overall operation of the server device 1000. The host processor 110 can manage a cache operation of a cache memory that will be described later using a cache manager (CM). The host processor 110 may include an operating memory (e.g., DRAM).

The cache manager (CM) may be embodied in software constituted by program codes or may be embodied by a separate hardware device inside the host processor 110. The cache manager (CM) may operate based on a page change algorithm. For example, the page change algorithm may be a first-in-first-out (FIFO) algorithm, a least recently used (LRU) algorithm, a least frequently used (LFU) algorithm, or an adaptive replacement cache (ARC) algorithm.

The cache manager (CM) may manage information about logical addresses LBA of the cache memory 120 and data corresponding to the logical addresses LBA in a list format. The cache manager (CM) may also manage information about logical addresses LBA of the auxiliary storage device 200 and data corresponding to the logical addresses LBA in a list format. In this case, the logical addresses LBA of the cache memory 120 and the logical addresses LBA of the auxiliary storage device 200 may be different forms of addresses.

The cache manager (CM) may determine whether a request page from an external device (not illustrated) exists in the cache memory 120 or in the auxiliary storage device 200 by referring to a list.

For example, in the case where the request page exists in the cache memory 120 (in the description that follows, it is referred to as ‘cache hit’), the cache manager (CM) can control cache data corresponding to the request page to be output from the cache memory 120 to the external device.

In the case where the request page, in contrast, does not exist in the cache memory 120 (in the description that follows, it is referred to as ‘cache miss’), the cache manager (CM) determines whether data corresponding to the request page exists in the auxiliary storage device 200. When data corresponding to the request page exists in the auxiliary storage device 200, the cache manager (CM) can control the corresponding data to be output to the cache memory 120 or to be directly output to the external device.

In the case where there is an update of a list (a change of page information between lists or an expulsion of page information from lists) according to the ‘cache hit’ or the ‘cache miss’, the cache manager (CM) may generate update information to transmit to the cache memory 120.

A process of generating the update information of the cache manager (CM) will be described in detail using drawings that will be described later.

The cache memory 120 may include a solid state drive (SSD). The cache memory 120 may include a memory controller 121, a dynamic random-access memory (DRAM) 122, and a NAND memory cell array 123.

The cache memory 120 may determine a characteristic (e.g., hot data or cold data) of cache data stored in the memory cell array 123 based on the update information transmitted from the host processor 110. A process of determining a characteristic of cache data based on the update information will be described in detail using drawings that will be described later.

The memory controller 121 may manage an input/output operation of the cache memory 120. For example, the memory controller 121 may perform an operation of converting a logical address LBA transmitted from the host processor 110 into a physical address PBA.

The memory controller 121 may transmit update information transmitted from the host processor 110 to the DRAM 122. The DRAM 122 may store the update information transmitted from the host processor 110. The memory cell array 123 may include a plurality of memory blocks (not illustrated). Each of the memory blocks includes a plurality of pages (not illustrated). The pages may be managed through the cache manager (CM) of the host processor 110.

The auxiliary storage device 200 may include a plurality of hard disk drives (HDD). The auxiliary storage device 200 has a larger storage capacity than the cache memory 120 but has a lower operating speed than the cache memory 120.

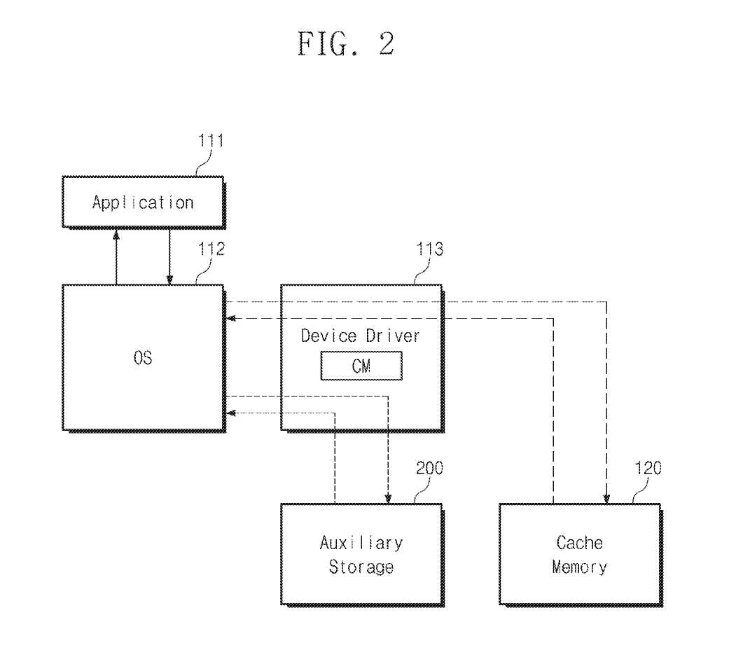

FIG. 2 is a block diagram illustrating a cache manager according to an embodiment of the disclosure. Referring to FIGS. 1 and 2, as mentioned above, the cache manager (CM) may be embodied in hardware or software. FIG. 2 illustrates an internal hierarchy diagram for the cache manager (CM), as embodied in software.

The cache manager (CM) includes an application unit 111, an operating system (OS) 112, and a device driver 113.

The application unit 111 may indicate a set of applications that operate in a general computer operating system. The application unit 111 may include various types of applications that perform a disk input/output.

The operating system 112 may provide a standard interface to the higher layer application unit 111 such that the disk input/output is executed.

The device driver 113 determines whether cache data corresponding to a request page of the operating system 112 exists in the cache memory 120 or the auxiliary storage device 200 with reference to a list. The device driver 113 may manage lists of a cache region according to a page change algorithm of the cache manager (CM). In the case where a list is changed according to the page change algorithm, the device driver 113 may generate update information to transmit to the cache memory 120.

For example, in the case where a page change operation is performed based on an adaptive replacement cache (ARC) algorithm, the device driver 113 has to manage page information that is two times greater than the total number (c) of pages of the cache region of the cache memory 120. The number (c) of pages of the cache region is referred to as a cache size. Details involved will be described using drawings that will be described later.

The device driver 113 manages page information of a page stored in the cache memory 120 as a list in response to a request page of an external device (not illustrated).

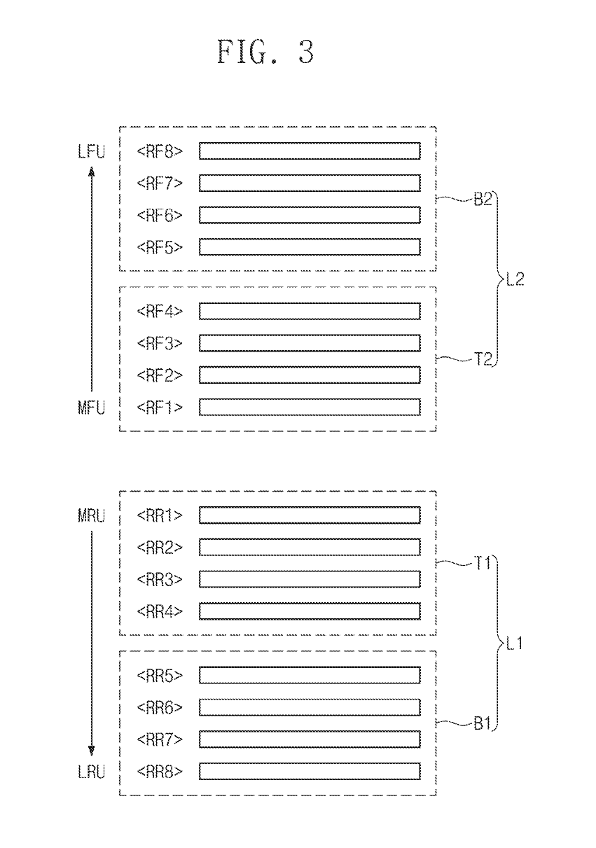

FIG. 3 is a conceptual diagram of lists managed by a cache manager (CM) according to an embodiment of the disclosure. Referring to FIGS. 1 through 3, it is assumed that the cache manager (CM) performs a page exchange operation based on an adaptive replacement cache (ARC) algorithm.

For brevity of description, it is assumed that the cache memory 120 uses 8 pages included in a block of the memory cell array 123 as a cache region. As widely known, in the case of performing a page exchange operation based on an ARC algorithm, the cache manager (CM) is required to manage page information two times (2c) as great as the cache size (c).

Referring to FIGS. 1 through 3, the cache manager (CM) may manage a first list L1 and a second list L2. The cache manager (CM) manages a reference ranking of first through eighth regions (RR1˜RR8) of the first list L1 based on recency.

The cache manager (CM) may manage pages accessed once from an external device (not illustrated). A first region (RR1) of the first list L1 has the most recently used (MRU) page and an eighth region (RR8) of the first list L1 has the least recently used (LRU) page.

The first list L1 includes a first page list T1 and a first erase list B1. The first page list T1 corresponds to a cache region of the cache memory 120. The first page list T1 includes first through fourth regions (RR1˜RR4). Page information stored in the first through fourth regions (RR1˜RR4) includes a logical address of cache data and information associated with the cache data.

The first erase list B1 stores a logical address among page information erased from the first page list T1 in fifth through eighth regions (RR5˜RR8) according to recency.

The second list L2 includes a second page list T2 and a second erase list B2. The second page list T2 corresponds to a cache region of the cache memory 120. The second page list T2 includes first through fourth regions (RF1˜RF4). Page information stored in the first through fourth regions (RF1˜RF4) includes a logical address of cache data and information associated with the cache data.

The second erase list B2 stores a logical address among page information erased from the second page list T2 in fifth through eighth regions (RF5˜RF8) according to frequency.

The regions of the first page list T1 and the regions of the second page list T2 correspond to the cache region of the cache memory 120 and the number of regions of each page list is adaptively changed. The sum of the number of the regions of the first page list T1 and the number of the regions of the second page list T2 remains the same as a size (c) of the cache region.

Referring to FIGS. 1 and 3, the cache manager (CM) stores page information about the most recently accessed page in the first region RR1 of the MRU page of the first list L1.

The cache manager (CM) stores information about a logical address of a page erased from the fourth region RR4 of the first page list L1 in the fifth through eighth regions (RR5˜RR8) according to recency. In this case, only a logical address of cache data is stored in the fifth through eighth regions (RR5˜RR8).

For example, the first erase list B1 stores information about a logical address among page information most recently erased from the first page list T1 in the fifth region RR5.

The cache manager (CM) may manage a reference ranking of first through eighth regions (RF1˜RF8) of the second list L2 according to frequency.

The cache manager (CM) may manage pages accessed at least twice from an external device using the second list L2. For example, the first region RF1 of the second list L2 has the most frequently used (MFU) page and the eighth region RF8 has the least frequently used (LFU) page.

The cache manager (CM) stores page information about the most recently accessed page in the first region RF1 of the MFU page of the second list L2. In this case, page information stored in the first through fourth regions (RF1˜RF4) of the second page list T2 includes a logical address of cache data and information associated with the cache data.

The cache manager (CM) stores a logical address of a page erased from the fourth region RF4 of the second page list T2 in the fifth through eighth regions (RF5˜RF8) according to frequency. That is, the second erase list B2 stores a logical address of a page most recently erased from the second page list T2 in the fifth region RF5.

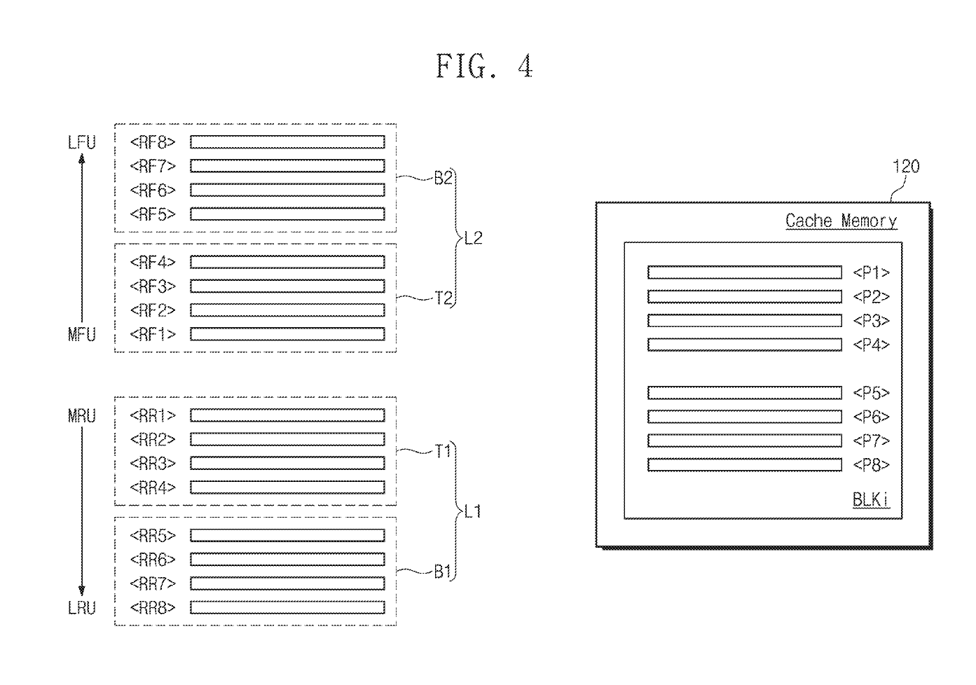

FIG. 4 is a conceptual diagram for explaining a relation between lists managed by a cache manager and a cache memory according to an embodiment of the disclosure.

Referring to FIGS. 1 through 4, it is assumed that the cache memory 120 of FIG. 4 uses address regions of first through eighth pages (P1˜P8) included in an arbitrary block BLKi of the memory cell array 123 as a cache region. In this case, the regions of the first list L1 and the second list L2 may be the same as or different from a size of a storage space of pages of the cache region of the cache memory 120. In the case of FIG. 4, a cache size (c) of the cache region is ‘8’.

The cache manager (CM) defines the number of regions storing page information among the regions (RR1˜RR8) of the first list L1 as a first entry (11). The cache manager (CM) defines the number of regions storing page information among the regions (RF1˜RF8) of the second list L2 as a second entry (12). When a change occurs in the first entry (11) or in the second entry (12), the cache manager (CM) generates update information.

The description mentioned in FIG. 3 may be applied to the first and second page lists T1 and T2, and the first and second erase lists B1 and B2 of FIG. 4 as it is.

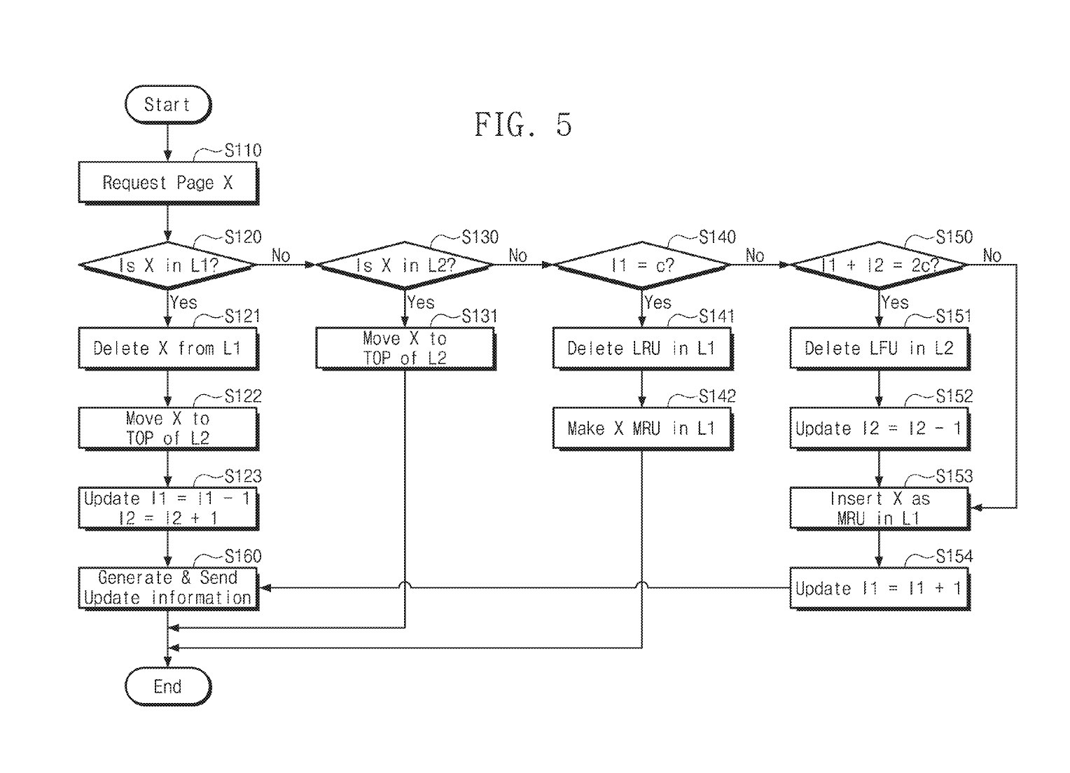

FIG. 5 is a flowchart illustrating an operation of a cache manager generating a list change signal according to an embodiment of the disclosure.

The cache manager (CM) of the host device 100 primarily checks whether page information associated with a request page (X) exists in a list associated with the cache memory 120 in response to a request of an external device (not illustrated).

In the case where page information associated with the request page (X) does not exist in the list associated with the cache memory 120, the cache manager (CM) of the host device 100 secondarily checks whether page information associated with the request page (X) exists in a list associated with the auxiliary storage device 200. For brevity of description, it is assumed that the request page (X) is read from the auxiliary storage device 200 by the host device 100.

Referring to FIGS. 1 through 5, in an operation S110, the host device 100 receives a request for a page (X).

In an operation S120, the cache manager (CM) may determine whether page information of the request page (X) exists in the first list L1.

In the case where it is determined that page information of the request page (X) exists in the first list L1, the cache manager (CM) deletes page information of a region corresponding to the request page (X) among the regions of the first list L1 in an operation S121.

In an operation S122, the cache manager (CM) may store page information about the request page (X) in the first region RF1 of the second list L2 having the MFU page.

In an operation S123, the cache manager (CM) may reduce the first entry 11 by 1 and may increase the second entry 12 by 1 according to the operations of S121 and S122. Subsequently, in an operation S160, the cache manager (CM) may generate update information about a list update of the four lists (T1, B1, T2, B2) and transmit the generated update information to the cache memory 120.

In the case where it is determined that page information of the request page (X) does not exist in the first list L1, the cache manager (CM) may determine whether the page information of the request page (X) exists in the second list L2 in an operation S130.

In the case where it is determined that the page information of the request page (X) exists in the second list L2, in an operation S131, the cache manager (CM) may store the page information of the request page (X) in the first region RF1 of the second list L2 having the MFU page. Subsequently, a corresponding process of the cache manager (CM) is finished.

In the case where it is determined that the page information of the request page (X) does not exist in the second list L2, the cache manager (CM) determines whether the first entry 11 is equal to a cache size (c) of the cache memory 120 in an operation S140.

In the case where the first entry 11 is equal to the cache size (c) of the cache memory 120, in an operation S141, the cache manager (CM) deletes page information of the eighth region RR8 of the first list L1 having the LRU page. The page information deleted in a region having the LRU page from each list may be expressed as eviction.

After that, in an operation S142, the cache manager (CM) may store the page information of the request page (X) in the first region RR1 of the first list L1 having the MRU page. Subsequently, a corresponding process of the cache manager (CM) is finished.

In the case where the first entry 11 is smaller than the cache size (c) of the cache memory 120, in an operation S150, the cache manager (CM) determines whether the sum of the first entry 11 and the second entry 12 is equal to two times (2c) as great as the cache size (c).

In the case where the sum of the first entry 11 and the second entry 12 is equal to two times (2c) as great as the cache size (c), in an operation S151, the cache manager (CM) evicts page information of the region RF8 having the LFU page of the second list L2. The page information of the evicted region RF8 may be included in update information to be transmitted to the cache memory 120.

In an operation S152, the cache manager (CM) reduces the second entry 12 by 1. In an operation S153, the cache manager (CM) inserts page information of request page (X) read from the auxiliary storage device 200 into the region RR1 having the MRU page of the first list L1. After that, in an operation S154, the cache manager (CM) increases the first entry 11 by 1.

In the case where the sum of the first entry 11 and the second entry 12 is not equal to two times (2c) as great as the cache size (c), the cache manager (CM) inserts S153 the page information of the request page (X) into the region RR1 having the MRU page of the first list L1. Subsequently, the cache manager (CM) increases S154 the first entry 11 by 1.

In the operation 160, the cache manager (CM) may generate update information about a list update of the four lists (T1, B1, T2, B2) and transmit the generated update information to the cache memory 120. It may be appreciated that the update information generated by the cache manager (CM) is included in a conventional signal to be transmitted to the cache memory 120.

For example, in the case where a protocol of the cache memory 120 is NVMe, the update information according to the disclosure may be applied to the cache memory 120 through a DSM command without generating an additional signal.

In the case where a protocol of the cache memory 120 is SATA or SCSI, update information may be independently generated to be transmitted to the cache memory 120 or information about a list update may be transmitted to the cache memory 120 using reserved bits of a specific command.

According to an embodiment of the disclosure, when the cache memory 120 performs a cache operation based on a solid state drive (SSD), the cache manager (CM) may transmit a list update according to a page change algorithm to the cache memory 120 through update information. Accordingly, the SSD-based cache memory 120 may perform an optimized garbage collection. The server device according to an embodiment of the disclosure may have improved performance and lifespan.

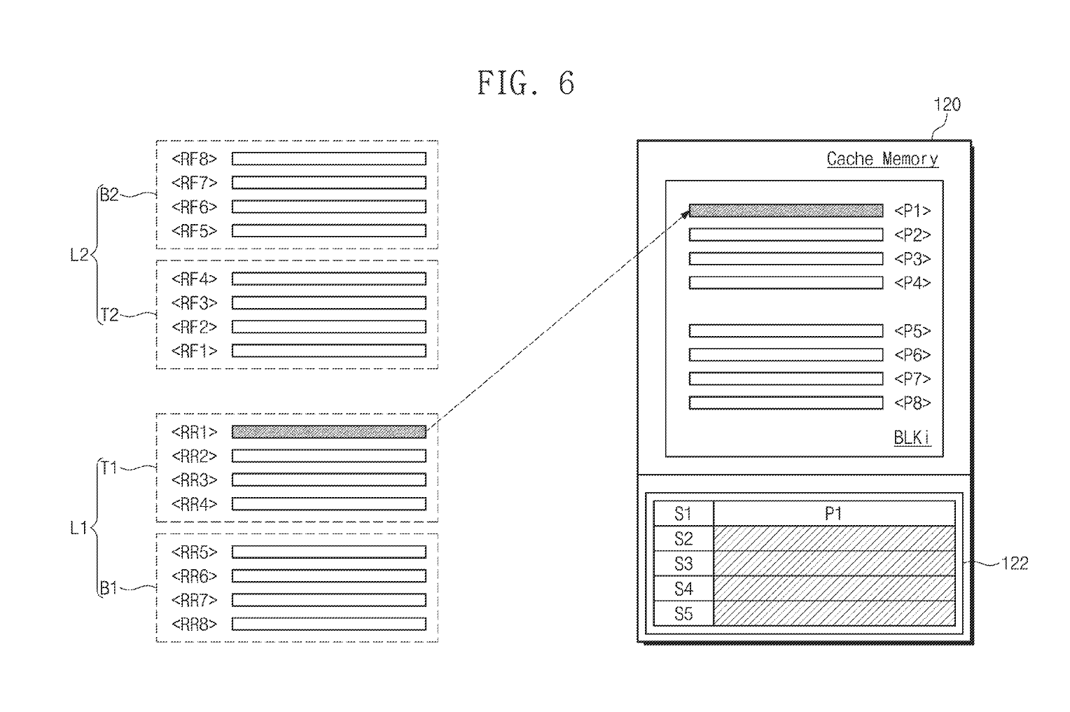

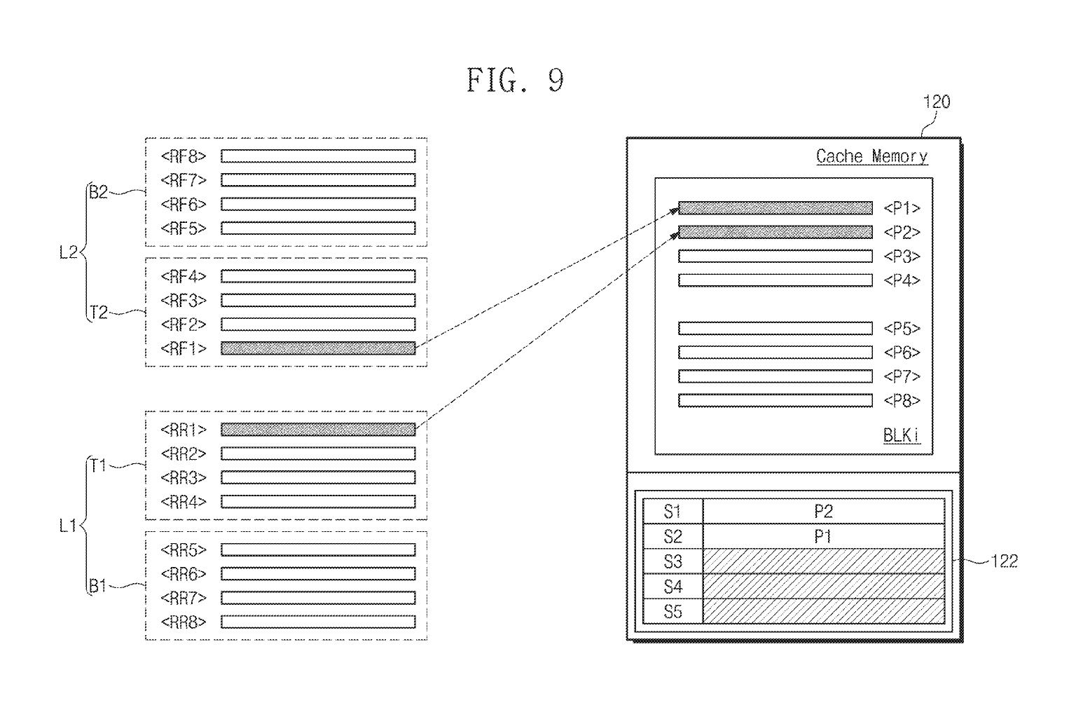

FIGS. 6 through 9 are conceptual diagrams of a process of generating a list change signal according to an embodiment of the disclosure. For brevity of description, it is assumed that the lists (T1, B1, T2, B2) managed by the cache manager (CM) and the cache regions P1˜P8 of the cache memory 120 are all empty at the beginning.

The cache memory 120 may manage a first state list S1, a second state list S2, a third state list S3, a fourth state list S4, and a fifth state list S5 based on received update information.

For example, the first state list S1 is associated with the first page list T1. When an update of the first page list T1 occurs, the first state list S1 is updated according to update information.

The second state list S2 is associated with the second page list T2. When an update of the second page list T2, the second state list S2 is updated according to the update information.

The third state list S3 is associated with the first erase list B1. When an update of the first erase list B1 occurs, the third state list S3 is updated according to the update information.

The fourth state list S4 is associated with the second erase list B2. When an update of the second erase list B2 occurs, the fourth state list S4 is updated according to the update information.

The fifth state list S5 is associated with the evicted page information. When an update of the first erase list B1 or the second erase list B2 occurs, the fifth state list S5 is updated according to the update information.

Referring to FIGS. 1 through 6, the cache manager (CM) stores page information of a first request page X1 in the first region RR1 of the first page list T1 through the operations S110, S120, S130, S140, S150 and S153.

The cache memory 120 stores the first request page X1 in the first page P1 of the cache memory 120. Page information stored in the first region RR1 includes information associated with cache data of the first page P1 and a logical address of the first page P1.

In the operation S154, the cache manager (CM) performs a list update that increases the first entry 11 of the first list L1 by 1. In the operation S160, the cache manager (CM) may generate update information according to an update of a list and transmit the generated update information to the cache memory 120.

The cache memory 120 may update a state list stored in the DRAM 122 according to the update information. Referring to FIG. 6, the cache memory 120 may determine that the cache data of the first page P1 is managed by the first page list T1. Referring to FIGS. 1 through 7, the cache manager (CM) stores page information of a second request page X2 in the first region RR1 of the first page list T1 through the operations S110, S120, S130, S140, S150 and S153. In this case, the second request page X2 is a page requested from an external device (not illustrated) and means a page different from the first request page X1.

The first list L1 uses recency as a reference ranking. Thus, the cache manager (CM) stores page information of the second page most recently accessed in the first region RR1 and moves the page information of the first request page X1 stored in the first region RR1 to the second region RR2.

The page information of the second page request X2 stored in the first region RR1 includes information associated with cache data of the second page P2 and a logical address of the second page P2. The cache memory 120 stores the second request page X2 in the second page P2 of the cache memory 120.

In the operation S154, the cache manager (CM) performs a list update that increases the first entry 11 of the first list L1 by 1. In the operation S160, the cache manager (CM) may generate update information according to the list update and transmit the generated update information to the cache memory 120.

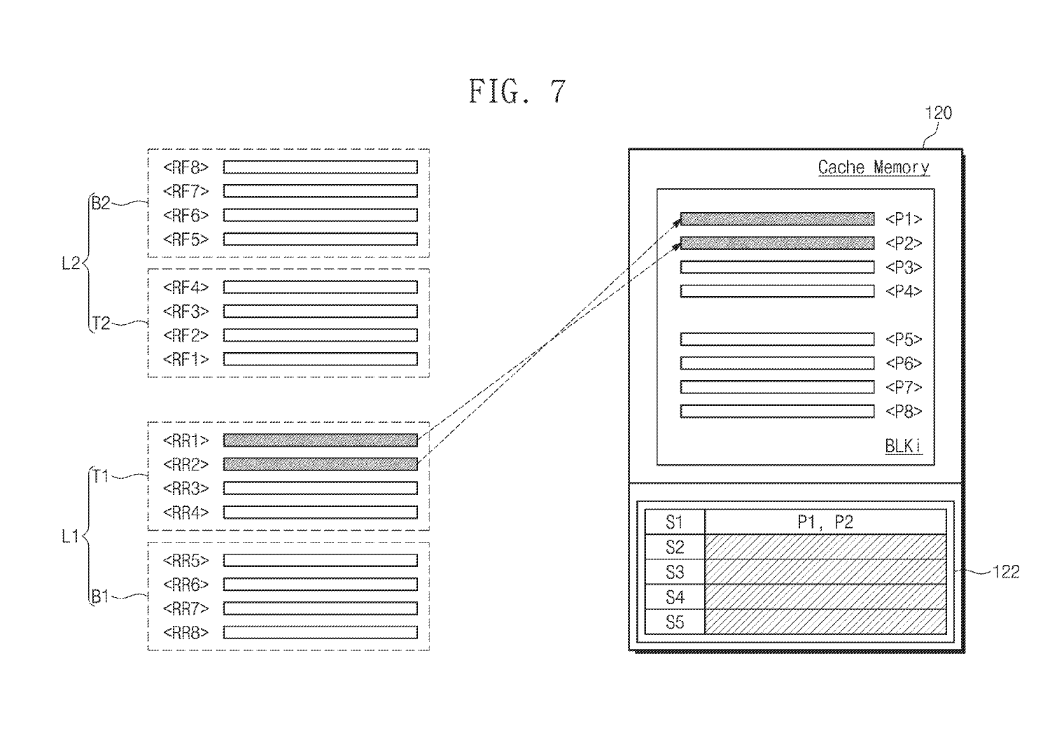

The cache memory 120 may update a list stored in the DRAM 122 according to the update information. Referring to FIG. 7, the cache memory 120 may determine that cache data of the first page P1 and cache data of the second page P2 are managed by the first page list T1.

Referring to FIGS. 1 through 8, a case in which the first request page X1 is requested from an external device (not illustrated) again is assumed. In the operation S120, the cache manager (CM) determines that page information of the first request page X1 already exists in the cache memory 120.

In the operation S121, the cache manager (CM) deletes the page information of the first request page X1 from the first list L1. In the operation S122, the cache manager (CM) stores the page information of the first request page X1 in the first region RF1 of the second list L2.

The page information of the first request page X1 is managed in the second list L2. In the operation S123, the cache manager (CM) reduces the first entry 11 of the first list L1 by 1 and increases the second entry 12 of the second list L2 by 1. In the operation S160, the cache manager (CM) may generate update information including changes of lists and transmit the generated update information to the cache memory 120.

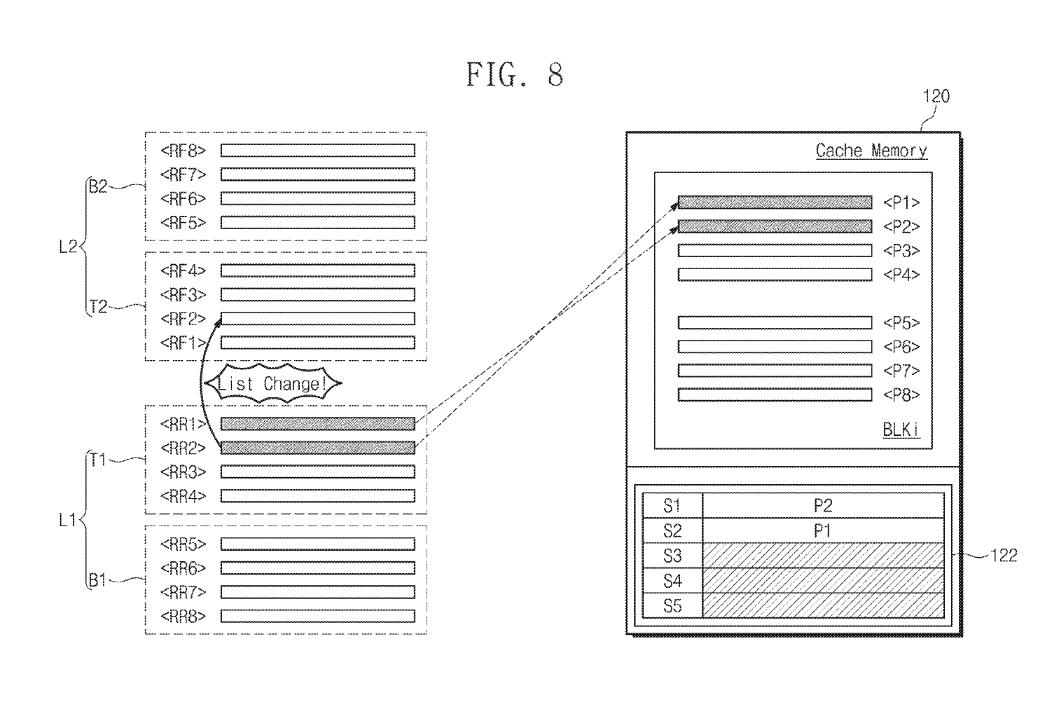

The cache memory 120 may update lists stored in the DRAM 122 according to the update information. Referring to FIG. 8, the cache memory 120 may determine that cache data of the first page P1 is managed by the second page list T2 and cache data of the second page P2 is managed by the first page list T2.

Referring to FIGS. 1 through 9, the lists (T1, T2, B1, B2) of the cache manager (CM) of which an update is completed through the operations S120 and S123, and the cache regions P1˜P8 of the cache memory 120 corresponding to the lists (T1, T2) are shown.

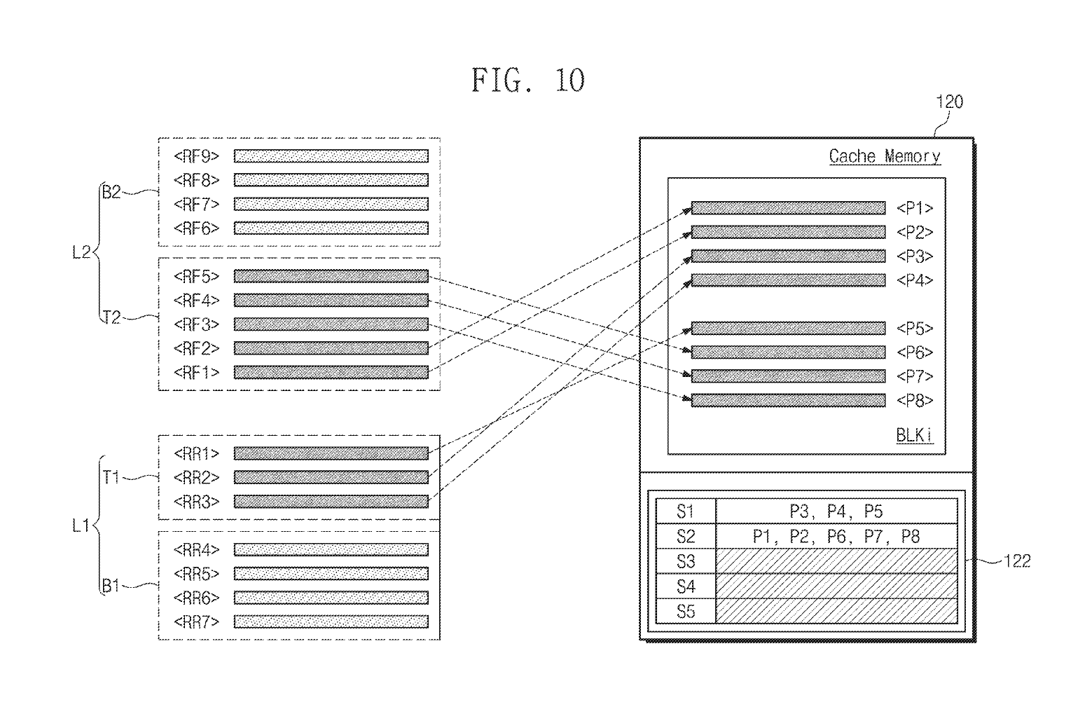

FIGS. 10 through 13 are conceptual diagrams of a process of generating a list change signal according to another embodiment of the disclosure. For brevity of description, referring to FIGS. 1 through 6 and 10 through 13, it is assumed that the lists (T1, B1, T2, B2) managed by the cache manager (CM) and the cache regions P1˜P8 of the cache memory 120 are in a state filled with page information and request pages X1˜X8.

It is assumed that the first page P1 of the cache region stores the first request page X1 as cache data, the second page P2 of the cache region stores the second request page X2 as cache data, the third page P3 of the cache region stores the third request page X3 as cache data, the fourth page P4 of the cache region stores the fourth request page X4 as cache data, the fifth page P5 of the cache region stores the fifth request page X5 as cache data, the sixth page P6 of the cache region stores the sixth request page X6 as cache data, the seventh page P7 of the cache region stores the seventh request page X7 as cache data, and the eighth page P8 of the cache region stores the eighth request page X8 as cache data.

Referring to FIG. 10, the first page list T1 includes first through third regions RR1˜RR3. The first erase list B1 includes fourth through seventh regions RR4˜RR7. In this case, the first entry 11 managed by the cache manager (CM) of FIG. 10 is ‘7’.

The first region RR1 stores information associated with the cache data of the fifth page P5 and information about a logical address LBA of the fifth page P5. The second region RR2 stores information associated with the cache data of the third page P3 and information about a logical address LBA of the third page P3. The third region RR3 stores information associated with the cache data of the fourth page P4 and information about a logical address LBA of the fourth page P4.

The fourth region RR4 stores information about a logical address among page information erased from a region having an LRU page of the first page list T1. The fourth region RR4 has MRU page in the first erase list B1.

The fifth region RR5 stores the information about the logical address transmitted from the fourth region RR4. For example, when new information about a logical address of an erase page is transmitted to the fourth region RR4, the existing information of the logical address stored in the fourth region RR4 is transmitted to the fifth region RR5.

The sixth region RR6 stores the information about the logical address transmitted from the fifth region RR5. For example, when new information about a logical address of an erase page is transmitted to the fifth region RR5, the existing information of the logical address stored in the fifth region RR5 is transmitted to the sixth region RR6.

The seventh region RR7 stores the information about the logical address transmitted from the sixth region RR6. For example, when new information about a logical address of an erase page is transmitted to the sixth region RR6, the existing information of the logical address stored in the sixth region RR6 is transmitted to the seventh region RR7.

When new information about a logical address of the erase page is transmitted to the seventh region RR7, the existing information of the logical address of the seventh region RR7 is evicted. In this case, the cache manager (CM) may include the evicted information in update information transmitted to the cache memory 120.

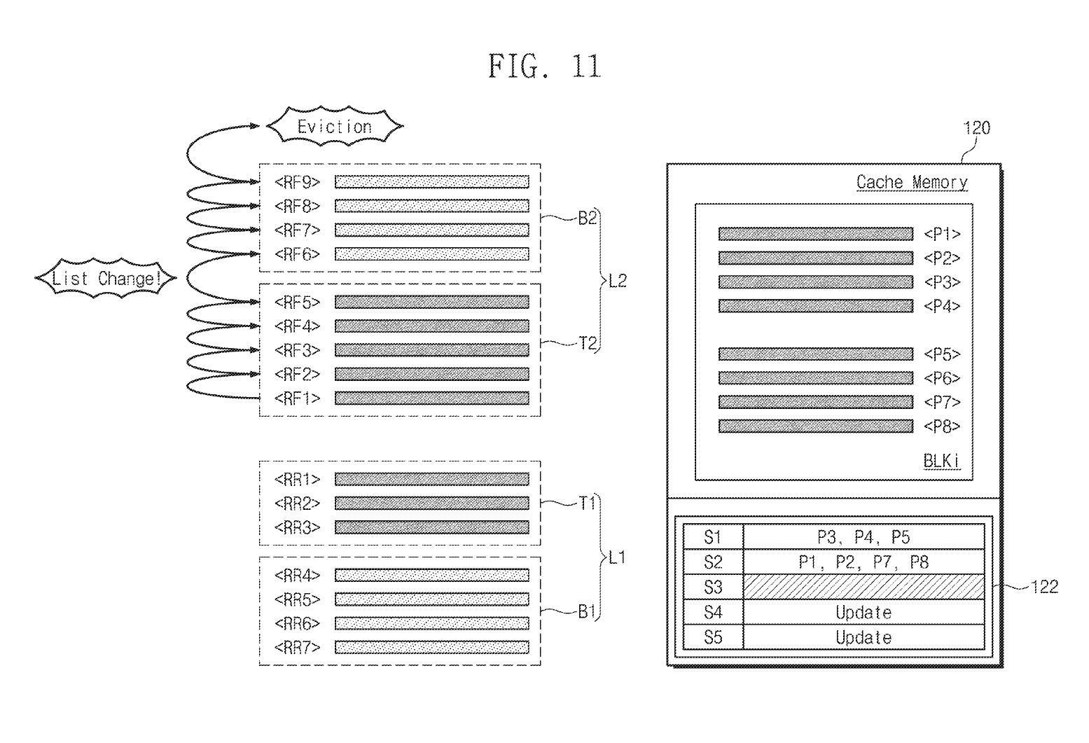

The second page list T2 includes first through fifth regions RF1˜RF5. The second erase list B2 includes sixth through ninth regions RF6˜RF9. The second entry managed by the cache manager (CM) of FIG. 11 is ‘9’.

The first region RF1 stores information associated with cache data of the second page P2 and information about a logical address LBA of the second page P2. The second region RF2 stores information associated with cache data of the first page P1 and information about a logical address LBA of the first page P1. The third region RF3 stores information associated with cache data of the eighth page P8 and information about a logical address LBA of the eighth page P8. The fourth region RF4 stores information associated with cache data of the seventh page P7 and information about a logical address LBA of the seventh page P7. The fifth region RF5 stores information associated with cache data of the sixth page P6 and information about a logical address LBA of the sixth page P6.

The sixth region RF6 stores information about a logical address among page information erased from a region (e.g., the fifth region RF5 of FIG. 11) having the LFU page of the second page list T2. The sixth region RF6 has the MFU page among regions of the second erase list B2.

The seventh region RF7 stores the information about the logical address transmitted from the sixth region RF6. For example, when new information about a logical address of an erase page is transmitted to the sixth region RF6, the existing information of the logical address stored in the sixth region RF6 is transmitted to the seventh region RF7.

The eighth region RF8 stores the information about the logical address transmitted from the seventh region RF7. For example, when new information about a logical address of an erase page is transmitted to the seventh region RF7, the existing information of the logical address stored in the seventh region RF7 is transmitted to the eighth region RF8.

The ninth region RF9 stores the information about the logical address transmitted from the eighth region RF8. For example, when new information about a logical address of an erase page is transmitted to the eighth region RF8, the existing information of the logical address stored in the eighth region RF8 is transmitted to the ninth region RF9.

When new information about a logical address of an erase page is transmitted to the ninth region RF9, the existing information of the logical address of the ninth region RF9 is evicted. In this case, the cache manager (CM) may include the evicted information in update information transmitted to the cache memory 120.

The cache memory 120 may update a list stored in the DRAM 122 according to update information. Referring to FIG. 10, in the cache memory 120, cache data of the third through fifth pages P3˜P5 is managed by the first page list T1 and cache data of the first, second, and sixth through eighth pages P1, P2, P6˜P8 is managed by the second page list T2.

Referring to FIG. 11, through the operation S120 and S130, the cache manager (CM) assumes a case of a cache miss that a request page X does not exist in the cache memory 120. In this case, since in the operation S140 of FIG. 5, the first entry 11 of ‘7’ is smaller than the size (c=8) of the cache region, the cache manager (CM) goes to the operation S150.

In the operation S150, the cache manager (CM) determines whether the sum of the first entry 11 and the second entry 12 is two times (2c=16) as great as the cache size (c). Since all the regions RR1˜RR7 of the first list L1 and all the regions RF1˜FR9 of the second list L2 store page information, the sum of the first entry 11 and the second entry 12 is ‘16’.

In the operation S151, the cache manager (CM) evicts page information stored in the ninth region RF9 of the LFU page of the second list L2. The evicted page information may be included in update information by the cache manager (CM). The update information is used to update an eviction list. In the operation S152, the second entry 12 of the second list L2 is reduced by 1 to become ‘8’. Page information of the first region RF1 moves to the second region RF2. Page information of the second region RF2 moves to the third region RF3. Page information of the third region RF3 moves to the fourth region RF4. Page information of the fourth region RF4 moves to the fifth region RF5.

Page information of the fifth region RF5 moves to the sixth region RF6. In this case, only information about a logical address of the fifth page P5 among page information of the fifth region RF5 is stored in the sixth region RF6.

In this case, a list to which the page information of the fifth region RF5 belongs is changed from the second page list T2 to the second erase list B2. The cache manager (CM) transmits update information to the cache memory 120 according to a list change. The update information is used to update the second erase list B2.

Page information of the seventh region RF7 moves to the eighth region RF8. Page information stored in the eighth region RF8 moves to the ninth region RF9. The second page list T2 includes first through fourth regions RF1˜RF4.

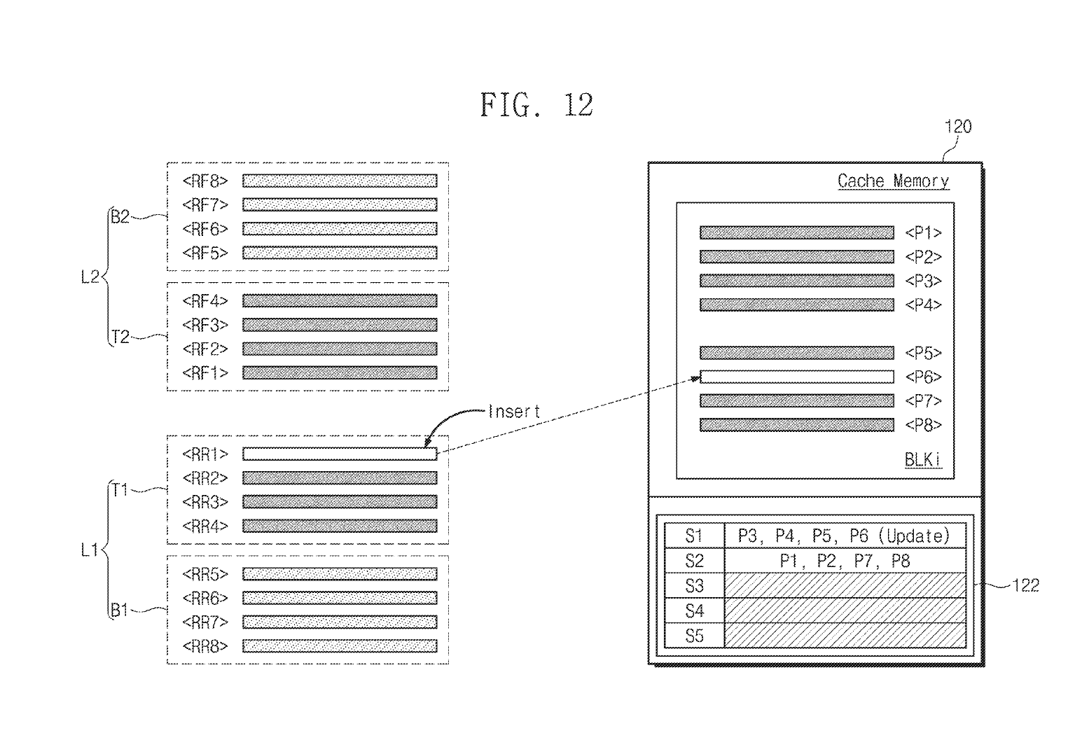

Referring to FIG. 12, in the operation S153, the cache manager (CM) inserts a new region to have the MRU page of the first list L1 and stores page information of a request page X in the inserted new region. The request page X is stored in the sixth page P6 of the cache memory 120.

In the operation S154, the first entry 11 increase by 1 to become ‘8’. In this case, the region of the first page list T1 increases due to the new region inserted into the first page list T1. The remaining regions, exclusive of the new region of the first page list T1 and first erase list B1 increase in reference ranking by 1. The page information of the eighth region RR8 is not evicted and is maintained.

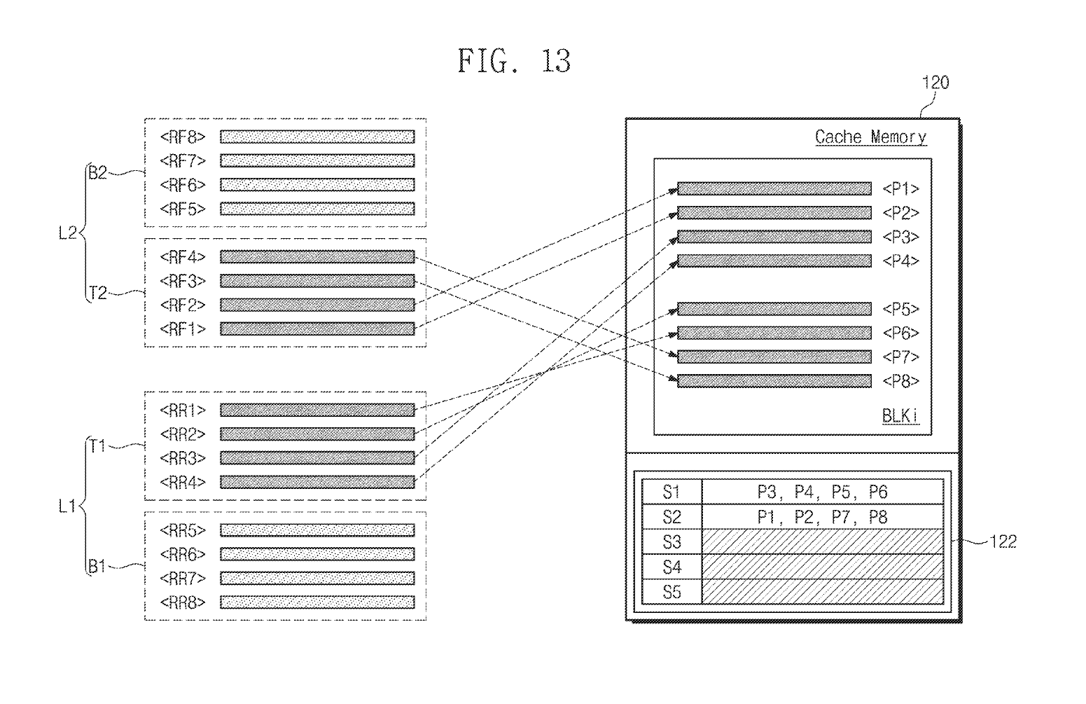

FIG. 13 illustrates a redefined relation between lists of the cache manager (CM) and the cache region after a page of the cache region is exchanged on the assumption of cache miss, as described above in connection with FIGS. 10-12.

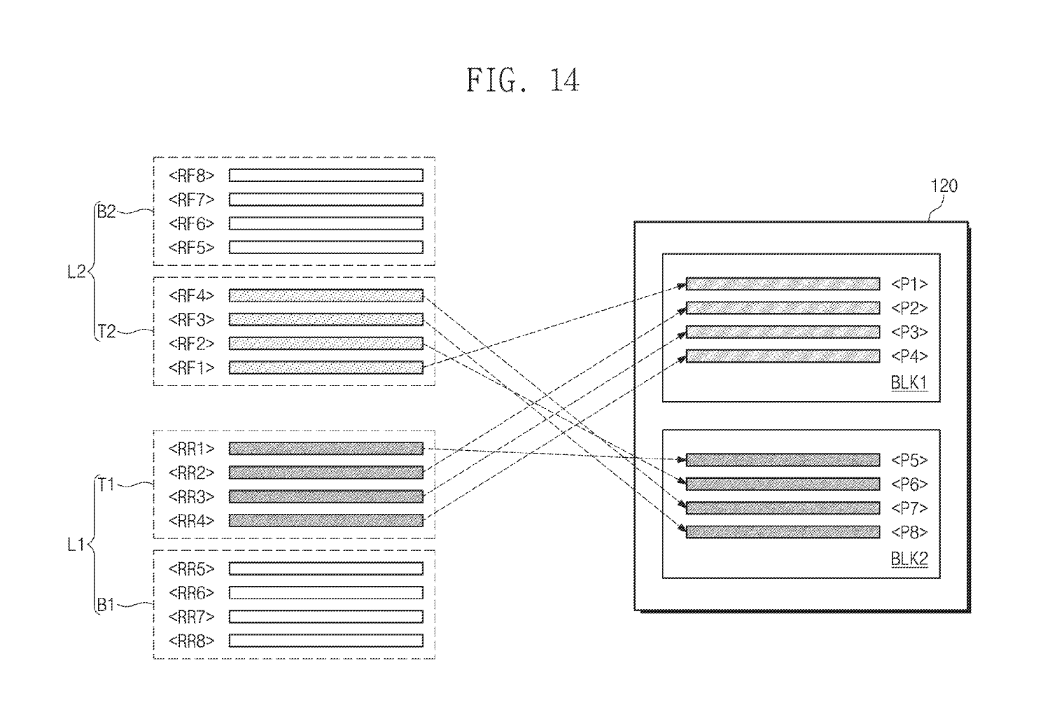

FIG. 14 is a drawing for explaining an operation of a cache manager in the case where a cache region includes a plurality of blocks according to an embodiment of the disclosure.

Referring to FIGS. 1 through 3 and 14, the description of FIG. 3 may be equally applied to the lists (T1, B1, T2, B2) managed by the cache manager (CM). The cache region may include logical addresses of the pages P1˜P8.

The cache region includes two blocks BLK1 and BLK2 from the cache memory 120 point of view. The cache memory 120 may collect pages managed by the same kind of list in an empty memory block (not illustrated) and manage them.

Referring to FIG. 14, among pages stored in the first block BLK1, pages (P2, P3, P4) are managed by the first page list T1 and a page P1 is managed by the second page list T2.

Among pages stored in the second block BLK2, a page P5 is managed by the first page list T1 and pages (P6, P7, P8) are managed by the second page list T2.

Probability of a list change in pages managed by the second list L2 based on frequency may be relatively smaller than that in pages managed by the first list L1. Thus, the pages managed by the second list L2 may be cold data compared with the pages managed by the first list L1.

As described above, the cache manager (CM) transmits update of lists according to a page exchange algorithm to the cache memory 120 through update information and thereby the cache memory 120 based on a solid state drive (SSD) may determine whether data stored in the cache region is hot data or cold data according to the update information. The cache memory 120 based on a solid state drive (SSD) may perform an optimized garbage collection or a read reclaim operation to improve performance and lifespan of the server device.

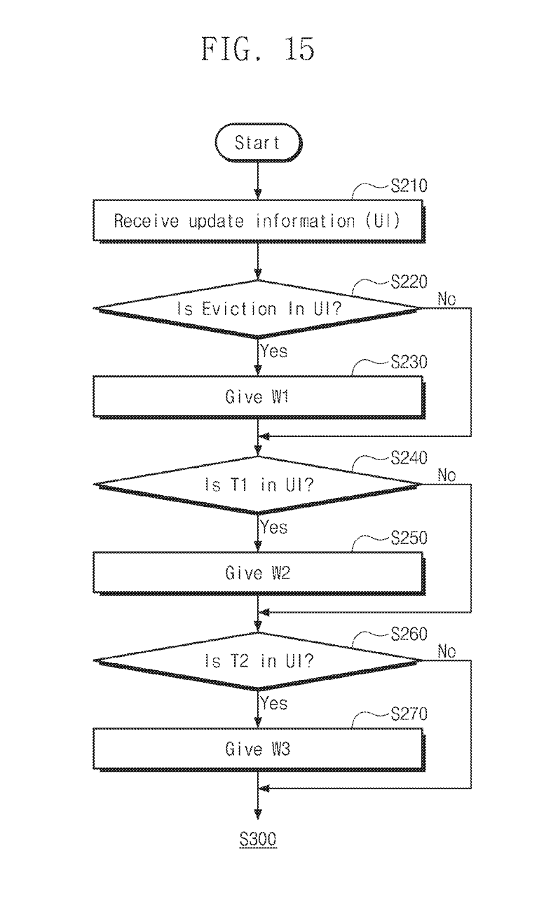

FIG. 15 is a drawing for explaining a process of assigning a weight value in units of blocks using a list change signal received according to an embodiment of the disclosure.

Referring to FIGS. 1 through 5, 14 and 15, in an operation S210, the cache memory 120 receives update information (UI). For brevity of description, it is assumed that the memory controller 121 of the cache memory 120 decodes the update information to obtain information of state lists S1˜S5 managed in the cache manager (CM) and loads the obtained information of the state lists S1˜S5 into the DRAM 122.

In an operation S220, the memory controller 121 of the cache memory 120 determines whether page information of a page evicted from the list exists with reference to the state lists S1˜S5 based on the update information (UI). In the case where the cache memory 120 determines that page information evicted from the list exists in the update information, in an operation S230, the memory controller 121 assigns a first weight value W1 to a memory block corresponding to the evicted page. Subsequently, the procedure goes to an operation S240.

In the case where the cache memory 120 determines that page information evicted from the list does not exist in the update information, the procedure goes to the operation S240. In the operation S240, the memory controller 121 determines whether a page newly managed by the first page list T1 exists with reference to the state lists S1˜S5 based on the update information.

In the case where it is determined that the page newly managed by the first page list T1 exists in the update information, in an operation S250, the memory controller 121 assigns a second weight value W2 to a block including the page newly managed by the first page list T1. Subsequently, the procedure goes to an operation S260. In the case where it is determined that a page newly managed by the first page list T1 does not exist in the update information, the procedure goes to the operation S260.

In the operation S260, the memory controller 121 determines whether a page newly managed by the second page list T2 exists with reference to the state lists S1˜S5 based on the update information.

In the case where it is determined that the page newly managed by the second page list T2 exists in the update information, in an operation S270, the memory controller 121 assigns a third weight value W3 to a block including the page newly managed by the second page list T2. Subsequently, the procedure goes to an operation S300. In the case where it is determined that a page newly managed by the second page list T2 does not exist in the update information, the procedure goes to the operation S300.

In this case, the first weight value W1 is set to be greater than the second weight value W2, and the second weight value W2 is set to be greater than the third weight value W3 in consideration of a characteristic of data (e.g., hot data or cold data) managed in each list.

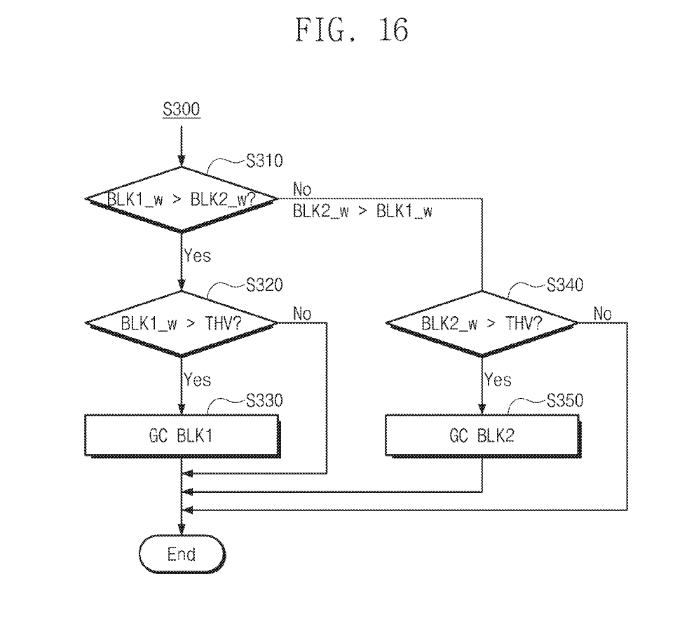

FIG. 16 is a drawing for explaining a process of performing garbage collection based on the weight value assigned according to an embodiment of the disclosure. Referring to FIGS. 1 through 5, and 14 through 16, in an operation S310, the memory controller 121 may determine whether the total weight value BLK1_w of the first block BLK1 is greater than the total weight value BLK2_w of the second block BLK2.

In the case where the total weight value BLK1_w of the first block BLK1 is greater than the total weight value BLK2_w of the second block BLK2, in an operation S320, the memory controller 121 determines whether the total weight value BLK1_w of the first block BLK1 is greater than a threshold value THV. In the case where the total weight value BLK1_w of the first block BLK1 is greater than the threshold value THV, the memory controller 121 may perform a garbage collection operation S330 with respect to the first block BLK1.

In the operation S310, in the case where the total weight value BLK2_w of the second block BLK2 is greater than the total weight value BLK1_w of the first block, in an operation S340, the memory controller 121 determines whether the total weight value BLK2_w of the second block BLK2 is greater than the threshold value THV. In the case where the total weight value BLK2_w of the second block BLK2 is greater than the threshold value THV, the memory controller 121 may perform a garbage collection operation S350 with respect to the second block BLK2.

In FIGS. 14 through 16, the second block BLK2 may include more pages managed by the second page list T2. Thus, when selecting a target on which a garbage collection operation is performed, the garbage collection may be more likely to be performed on the first block BLK1 compared with the second block BLK2. Through the methods described above, a garbage collection operation may be performed at an optimal time and thereby total lifespan and performance of the server device may increase.

Although not illustrated through the drawing, a cache region of the cache memory 120 may be separately managed by moving pages managed by the first page list T1 to one block and moving pages managed by the second page list T2 to another block. That is, the disclosure may increase the total lifespan and performance of the server device by collecting pages or blocks having similar data characteristics in one block to manage them.

More read operations are performed on pages of a cache region managed by the second page list T2 compared with pages of a cache region managed by the first page list T1. As a result, a device characteristic of pages managed by the second page list T2 is likely to be rapidly deteriorated. Thus, the cache memory 120 may operate such that a read reclaim operation is more frequently performed on the pages managed by the second page list T2 compared with the pages managed by the first page list T1.

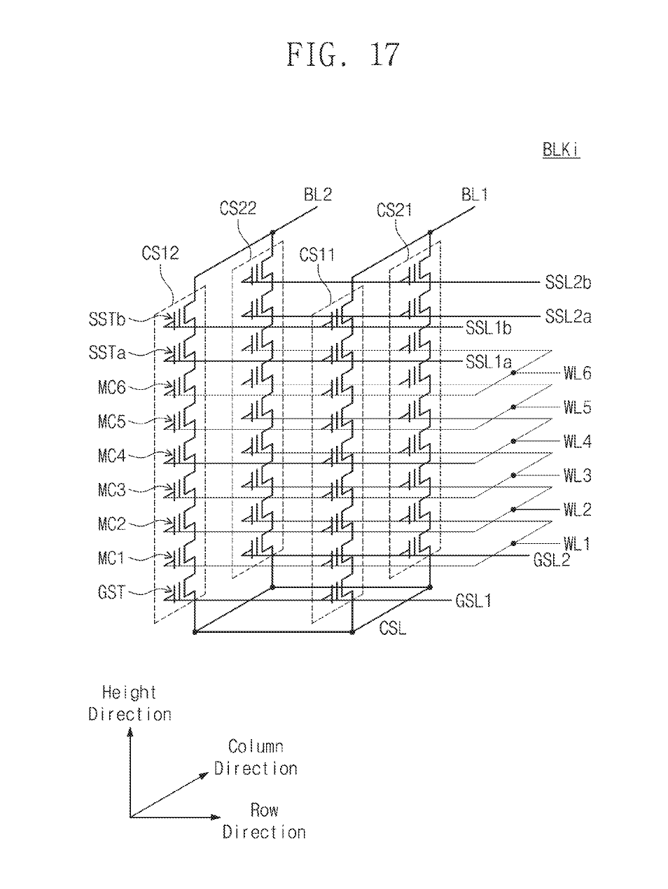

FIG. 17 is a block diagram illustrating a memory cell array according to another embodiment of the disclosure. FIG. 17 is a circuit diagram illustrating a memory block BLKi according to another embodiment of the disclosure.

Referring to FIGS. 1 through 17, the memory block BLKi includes a plurality of cell strings (CS11˜CS21, CS12˜CS22). The cell strings (CS11˜CS21, CS12˜CS22) may be arranged along a row direction and a column direction to form rows and columns.

For example, the cell strings CS11 and CS12 arranged along the row direction may form a first row and the cell strings CS21 and CS22 arranged along the row direction may form a second row. The cell strings CS11 and CS21 arranged along the column direction may form a first column and the cell strings CS12 and CS22 arranged along the column direction may form a second column.

Each cell string may include a plurality of cell transistors. The cell transistors include ground select transistors GST, memory cells MC1˜MC6, and string select transistors SSTa and SSTb. The ground select transistor GST, the memory cells MC1˜MC6 and string select transistors SSTa and SSTb of each cell string may be laminated in a height direction perpendicular to a plane (e.g., a plane on a substrate of the memory block BLKi) on which the cell strings (CS11˜CS21, CS12˜CS22) are arranged along rows and columns.

The cell transistors may be charge trap type transistors having threshold voltages that vary depending on the amounts of charges trapped in an insulating layer.

Sources of the lowermost ground select transistors GST may be connected to a common source line CSL in common.

Control gates of the ground select transistors GST of the cell strings (CS11˜CS21, CS12˜CS22) may be connected to ground select lines GSL1 and GSL2 respectively. Ground select transistors of the same row may be connected to the same ground select line and ground select transistors of different rows may be connected to different ground select lines. For example, the ground select transistors GST of the cell strings CS11 and CS12 of the first row may be connected to a first ground select line GSL1 in common and the ground select transistors GST of the cell strings CS21 and CS22 of the second row may be connected to a second ground select line GSL2 in common.

Control gates of memory cells MC1˜MC6 located at the same height (or order) from the substrate (or ground select transistors GST) may be connected to one word line in common, and control gates of memory cells MC1˜MC6 located at different heights (or orders) from the substrate (or ground select transistors GST) may be connected to different word lines WL1˜WL6 respectively. For example, the memory cells MC1 are connected to the word line WL1 in common. The memory cells MC2 are connected to the word line WL2 in common. The memory cells MC3 are connected to the word line WL3 in common. The memory cells MC4 are connected to the word line WL4 in common. The memory cells MC5 are connected to the word line WL5 in common. The memory cells MC6 are connected to the word line WL6 in common.

At first string select transistors SSTa of the same height (or order) of the cell strings (CS11˜CS21, CS12˜CS22), control gates of the first string select transistors SSTa of different rows are connected to different string select lines SSL1a˜SSL2a respectively. For example, the first string select transistors SSTa of the cell strings CS11 and CS12 are connected to the string select line SSL1a in common. The first string select transistors SSTa of the cell strings CS21 and CS22 are connected to the string select line SSL2a in common.

At second string select transistors SSTb of the same height (or order) of the cell strings (CS11˜CS21, CS12˜CS22), control gates of the second string select transistors SSTb of different rows are connected to different string select lines SSL1b˜SSL2b respectively. For example, the second string select transistors SSTb of the cell strings CS11 and CS12 are connected to the string select line SSL1b in common. The second string select transistors SSTb of the cell strings CS21 and CS22 are connected to the string select line SSL2b in common.

That is, cell strings of different rows are connected to different string select lines. String select transistors of the same height (or order) of cell strings of the same row are connected to the same string select line. String select transistors of different heights (or orders) of cell strings of the same row are connected to different string select lines.

String select transistors of cell strings of the same row may be connected to one string select line in common. For example, the string select transistors SSTa and SSTb of the cell strings CS11 and CS12 of the first row may be connected to one string select line in common. The string select transistors SSTa and SSTb of the cell strings CS21 and CS22 of the second row may be connected to one string select line in common.

Columns of the cell strings (CS11˜CS21, CS12˜CS22) are connected to different bit lines BL1 and BL2 respectively. For example, the string select transistors SSTb of the cell strings CS11˜CS21 of the first column are connected to the bit line BL1 in common. The string select transistors SSTb of the cell strings CS12˜CS22 of the second column are connected to the bit line BL2 in common.

The cell strings CS11 and CS12 may form a first plane. The cell strings CS21 and CS22 may form a second plane.

In a memory block BLKi, memory cells of each height of each plane may form a physical NAND page. The physical NAND page may be a write unit and a read unit of the memory cells MC1˜MC6. For example, one plane of the memory block BLKi may be selected by the string select lines SSL1a, SSL1b, SSL2a and SSL2b. When a turn-on voltage is supplied to the string select lines SSL1a and SSL1b and a turn-off voltage is supplied to the string select lines SSL2a and SSL2b, the cell strings CS11 and CS12 of the first plane are connected to the bit lines BL1 and BL2. That is, the first plane is selected. When a turn-on voltage is supplied to the string select lines SSL2a and SSL2b and a turn-off voltage is supplied to the string select lines SSL1a and SSL1b, the cell strings CS21 and CS22 of the second plane are connected to the bit lines BL1 and BL2. That is, the second plane is selected. In the selected plane, one row of the memory cells MC1˜MC6 may be selected by the word lines WL1˜WL6. In the selected row, a select voltage may be applied to the second word line WL2 and an unselect voltage may be applied to the remaining word lines WL1 and WL3˜WL6. That is, a physical page corresponding to the second word line WL2 of the second plane may be selected by adjusting voltages of the string select lines SSL1a, SSL1b, SSL2a and SSL2b and the word lines WL1˜WL6. In the memory cells MC2 of the selected physical page, a write or read operation may be performed.

In the memory block BLKi, an erase of the memory cells MC1˜MC6 may be performed in units of memory blocks or in units of sub blocks. When an erase operation is performed in units of memory blocks, all the memory cells MC1˜MC6 of the memory block BLKi may be erased at the same time according to an erase request (e.g., an erase request from an external memory controller). When an erase operation is performed in units of sub blocks, a part of the memory cells MC1˜MC6 of the memory block BLKi may be erased at the same time according to an erase request and the remaining memory cells may be erase-prohibited. A low voltage (for example, a ground voltage or a voltage having a level similar to the ground voltage) may be supplied to a word line connected to memory cells MC1˜MC6 being erased and a word line connected to the erase-prohibited memory cells may be floated.

The memory block BLKi may include a physical storage space identified by a block address. Each of the word lines WL1˜WL6 may correspond to a physical storage space identified by a row address. Each of the bit lines BL1 and BL2 may correspond to a physical storage space identified by a column address. Each of string select lines (SSL1a and SSL2a, or SSL1b and SSL2b) of a different row or ground select lines GSL1 or GSL2 of different row may correspond to a physical storage space identified by a plane address.

The memory block BLKi illustrated in FIG. 17 is illustrative. A technical spirit of the disclosure is not limited to the memory block BLKi illustrated in FIG. 17. For example, the number of rows of cell strings may increase or decrease. As the number of rows of cell strings changes, the number of string select lines or ground select lines connected to rows of the cell strings, and the number of cell strings connected to one bit line may also be changed.

The number of columns of cell strings may increase or decrease. As the number of columns of cell strings is changed, the number of bit lines connected to columns of the cell strings, and the number of cell strings connected to one string select line may also be changed.

A height of the cell strings may increase or decrease. For example, the number of ground select transistors, memory cells or string select transistors that are laminated to each cell string may increase or decrease.

Memory cells MC that belong to one physical NAND page may correspond to at least three logical pages. For example, k (k is a positive integer greater than 2) number of bits may be programmed in one memory cell MC. In the memory cells MC that belong to one physical NAND page, k number of bits being programmed in each memory cell may form k number of logical NAND pages respectively.

For example, one physical NAND page includes a physical storage space identified by a block address, a row address, a column address, and a plane address. One physical NAND page may include at least two logical NAND pages. Each of the logical NAND pages may include a logical storage space identified by an additional address (or offset) identifying logical NAND pages in addition to an address of the physical NAND page.

In an embodiment of the present disclosure, a three dimensional (3D) memory array is provided. The 3D memory array is monolithically formed in one or more physical levels of arrays of memory cells having an active area disposed above a silicon substrate and circuitry associated with the operation of those memory cells, whether such associated circuitry is above or within such substrate. The term “monolithic” means that layers of each level of the array are directly deposited on the layers of each underlying level of the array.

In an embodiment of the present disclosure, the 3D memory array includes vertical NAND strings that are vertically oriented such that at least one memory cell is located over another memory cell. The at least one memory cell may comprise a charge trap layer. Each vertical NAND string may include at least one select transistor located over memory cells, the at least one select transistor having the same structure with the memory cells and being formed monolithically together with the memory cells.

The following patent documents, which are hereby incorporated by reference, describe suitable configurations for three-dimensional memory arrays, in which the three-dimensional memory array is configured as a plurality of levels, which word lines and/or bit lines shared between levels: U.S. Pat. Nos. 7,679,133; 8,553,466; 8,654,587; 8,559,235; and US Pat. Pub. No. 2011/0233648.

According to embodiments of the disclosure, a server device including a cache memory having improved performance and lifespan and a method of operating the same may be provided by transmitting update information of lists managed by a page algorithm to the cache memory.

As is traditional in the field, embodiments may be described and illustrated in terms of blocks which carry out a described function or functions. These blocks, which may be referred to herein as units or modules or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by firmware and/or software. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

The above-disclosed subject matter is to be considered illustrative, and not restrictive, and the appended claims are intended to cover all such modifications, enhancements, and other embodiments, which fall within the true spirit and scope of the disclosure. Thus, to the maximum extent allowed by law, the scope of the disclosure is to be determined by the broadest permissible interpretation of the following claims and their equivalents, and shall not be restricted or limited by the foregoing detailed description.

What is claimed is:

1. A method executed by a processor of a server device, the method comprising:
storing cache data in a cache memory;
storing a first list associated with first cache data having a first characteristic among the cache data and a second list associated with second cache data having a second characteristic among the cache data in an operating memory; and
in a case where at least one of the first and second lists is updated, transmitting update information to the cache memory, wherein
the first list comprises a first region storing first page information of the first cache data and a second region storing second page information of the first cache data, and the second list comprises a third region storing third page information of the second cache data and a fourth region storing fourth page information of the second cache data.

2. The method of claim 1, wherein the first characteristic is associated with recency and the second characteristic is associated with frequency.

3. The method of claim 2, wherein:
each of the first through second regions stores page information having reference rankings of a most-recently used (MRU) page to a least-recently used (LRU) page, and
each of the third and fourth regions stores page information having reference rankings of a most-frequently used (MFU) page to a least-frequently used (LFU) page.

4. The method of claim 3, wherein when page information having the reference ranking of the LRU page of the first region is deleted, the deleted page information is stored in a region having the reference ranking of the MRU page of the second region.

5. The method of claim 3, wherein when page information having the reference ranking of the LFU page of the third region is deleted, the deleted page information is stored in a region having the reference ranking of the MFU page of the fourth region.

6. The method of claim 1, wherein the storing cache data in a cache memory comprises, when request data does not exist in the cache memory, storing data read through an auxiliary memory device as the cache data of the cache memory.

7. The method of claim 1, further comprising determining that the first cache data associated with the first list is hot data and the second cache data associated with the second list is cold data based on the update information.

8. The method of claim 7, wherein a performance ratio of a read reclaim is more highly set in a storage region associated with the first cache data as compared with a storage region associated with the second cache data.

9. The method of claim 1, further comprising performing a garbage collection according to a data characteristic stored in the cache memory based on the update information.

10. A server device comprising:
a cache memory storing cache data;
an auxiliary memory device including a plurality of hard disk drives; and
a processor storing a first list associated with first cache data having a first characteristic among the cache data and a second list associated with second cache data having a second characteristic among the cache data in an operating memory, wherein
in a case where at least one of the first list and the second list is updated, the processor transmits update information to the cache memory.

11. The server device of claim 10, wherein:
each of memory blocks of the cache memory comprises cell strings arranged on a substrate,
each of the cell strings comprises at least one select transistor and memory cells laminated to the substrate in a direction perpendicular to the substrate, and
the at least one select transistor and each of the memory cells comprise a charge trap layer.

12. The server device of claim 10, wherein the cache memory is used as a cache region of the auxiliary memory device.

13. The server device of claim 10, wherein the cache memory is a solid state drive (SSD).

14. The server device of claim 13, wherein the cache memory performs a garbage collection operation or a read reclaim operation based on the update information.

15. The server device of claim 10, wherein the processor is configured to determine a hit and a miss associated with the cache memory.

16. A data server comprising:
a cache memory device having a nonvolatile memory; and
a cache memory manager that:
receives a request for a page of data,
determines a first affirmative outcome when the requested page is stored by the nonvolatile memory and has an address identified by either a first list or a second list stored by the cache memory manager and otherwise determines a negative outcome, wherein all page addresses identified by the first list are mutually exclusive with all page addresses identified by the second list, and
moves the address of the requested page to a position within the second list indicating the requested page is the most-recently requested page identified by the second list, in response to determining the first affirmative outcome.

17. The data server of claim 16, wherein the cache memory manager further stores the address of the requested page in a position within the first list indicating the requested page is the most-recently requested page identified by the first list, in response to determining the negative outcome.

18. The data server of claim 17, wherein the cache memory manager, in response to determining the negative outcome, further:
determines a second affirmative outcome when the total number of pages identified by the first and second lists equals twice the maximum number of pages that can be stored by the nonvolatile memory, and
removes from the second list an address of another page that is located in a position within the second list indicating the other page is the least-recently requested page identified by the second list, in response to determining the second affirmative outcome.

19. The data server of claim 16, wherein the cache memory manager, in response to determining the negative outcome, further:
determines a second affirmative outcome when the number of pages identified by the first list equals the maximum number of pages that can be stored by the nonvolatile memory, and
removes from the first list an address of another page that is located in a position within the first list indicating the other page is the least-recently requested page identified by the first list, in response to determining the second affirmative outcome.

20. The data server of claim 16, further comprising:
a volatile memory, wherein:
the cache memory manager stores within the volatile memory:
a third list identifying each page stored in the nonvolatile memory having an address within the first list, and
a fourth list identifying each page stored in the nonvolatile memory having an address within the second list.
